(19) United States
(12) Patent Application Publication
(10) Pub. No.: US 2004/0027942 A1
(43) Pub. Date: Feb. 12, 2004

(54) Recording medium reproducing apparatus and method and recording medium recording/reproducing apparatus

(76) Inventor: Yoichiro Sako, Tokyo (JP)

Correspondence Address: Jay H Maioli, Cooper & Dunham, 1185 Avenue of the Americas, New York, NY, 10036, US

(21) Appl. No.: 10/381,265

(22) PCT Filed: Jul. 29, 2002
(86) PCT No.: PCT/JP02/07660

(30) Foreign Application Priority Data
Jul. 31, 2001 (JP) 2001-232132

(51) Int. Cl. G11B 7/00

(52) U.S. Cl. 369/47.12; 369/53.21

(57) ABSTRACT

A recording medium reproducing method is disclosed. At least first quality content data and second quality content data whose quality is lower than the first quality content data have been recorded on a recording medium. In a reproduction mode of the recoding medium, the first quality content data is read from the recording medium. After the first quality content data is decoded, the decoded data is output as output data.

### TECHNICAL FIELD

The present invention relates to a recording medium reproducing apparatus, a method thereof, and a recording medium recording and reproducing apparatus, in particular, to those for recording content data for example a digital audio signal to a recording medium having a relatively large storage capacity.

### BACKGROUND ART

In recent years, discs corresponding to an SACD (Super Audio CD: Registered Trademark) standard and discs corresponding to a DVD (Digital Versatile Disc or Digital Video Disc) audio standard which allow higher quality digital audio data than so-called CDs (Compact Discs) to be recorded have been placed on the market. Digital audio signals are permitted to be output from those discs only when they have been down-converted to lower quality signals than those of CDs from a viewpoint of copyright protection.

FIG. 1 shows an outlined structure of a player corresponding to a conventional DVD audio standard. Reference numeral 1 represents an optical disc on which a digital audio signal has been recorded corresponding to for example the DVD audio standard. The optical disc 1 is rotated by a spindle motor 2. Information recorded on the optical disc 1 is red by an optical pickup 3. An output signal which is read by the optical pickup 3 is supplied to an RF processing block 4. An RF signal which is output from the RF processing block 4 is supplied to a demodulating portion 5. A rotation of the spindle motor 2, a tracking servo and a focus servo of the optical pickup 3, and an operation of a motor (not shown) which travels the optical pickup 3 in a disc radial direction are controlled by a servo block 6.

The demodulating portion 5 demodulates the RF signal corresponding to an 8-16 converting method. The demodulating portion 5 outputs eight-bit data corresponding to a 16-bit code. Output data of the demodulating portion 5 is supplied to an error correcting circuit 7. The error correcting circuit 7 corrects an error of data with an error correction code which is a product code corresponding to Reed-Solomon code. Output data whose error has been corrected by and output from the error correcting circuit 7 is supplied to a decrypter 8 which decrypts encrypted data.

On a rewritable DVD, media ID data is recorded in a reproduction only area (ROM portion) at the innermost periphery portion. Content data encrypted with key data which is a hash value of the media ID data and MKB (Media Key Block) is recorded on the disc so that the disc is protected from being illegally copied. The media ID data is a value unique for each disc. Since the user cannot rewrite the media ID data, even if he or she illegally copies the data portion to another disc, since the media ID data is different from that of the original disc, the data portion cannot be decrypted. The decrypter 8 decrypts the data portion using the media ID data of the optical disc 1.

Digital audio data which is output from the decrypter 8 is supplied to a D/A converter 10 through a low pass filter 9. An analog reproduction audio signal is obtained from an output terminal 11. When the digital audio signal has been sampled at a sampling frequency of 96 kHz and quantized with 24 bits, the pass band of the low pass filter 9 is 192 kHz. An output signal of the decrypter 8 is supplied to a down converter 12. The down converter 12 outputs a digital audio signal which has been sampled at a frequency of 44.1 kHz and quantized with 16 bits as a signal converted by the down converter 12. The output signal of the down converter 12 is obtained from an output terminal 13. The quality of the obtained digital audio signal is lower than that of a signal corresponding to the DVD audio standard and equal to that of a digital audio signal of a CD.

In the conventional structure, a digital output signal is treated as data which is recorded on another recordable medium. However, when a digital output signal is converted into an analog signal, an low quality audio signal is reproduced. In this case, a lower quality audio signal than a reproduced sound corresponding to the DVD audio standard is reproduced. If the user does not clearly recognize that the quality of a digital signal which is output from a player is low, he or she will not be satisfied with the quality of the reproduced sound of the digital output signal which is output from the player. From the viewpoint of the player side, a signal processing portion such as a down converter which determines the quality is required. As a result, hardware will become complicated and the power consumption will increase.

Therefore, an object of the present invention is to provide a recording medium reproducing apparatus, a method thereof, and a recording medium recording and reproducing apparatus that allow high quality content data and low quality content data to be recorded on a recording medium, only the high quality content data to be reproduced, only the low quality content data to be output as digital data.

### DISCLOSURE OF THE INVENTION

To solve the forgoing problem, claim 1 of the present invention is a recording medium reproducing apparatus, comprising: a head portion for reading data from a recording medium on which at least first quality content data and second quality content data have been recorded; a decode processing portion for receiving an output signal of the head portion and decoding the received output signal; and a controlling portion for causing the head portion to read the first quality content data from the recording medium, supplying the first quality content data to the decode processing portion, and outputting output data of the decode processing portion in a reproduction mode of the recording medium.

Claim 7 of the present invention is a recording medium reproducing method, comprising the steps of: in a reproduction mode of a recording medium on which at least first quality content data and second quality content data whose quality is lower than the first quality content data have been recorded, reading the first quality content data from the recording medium; decoding the first quality content data which has been read; and outputting the decoded data as output data.

Claim 13 of the present invention is a recording medium recording and reproducing apparatus, comprising: a read head portion for reading data from a first recording medium on which at least first quality content data and second quality content data whose quality is lower than the first quality content data have been recorded; a decode processing portion for receiving an output signal of the header portion and decoding the received output signal; a recording portion for encoding output data of the decode processing portion so as to record the encoded data to a second recording medium; a controlling portion for causing the read head portion to read the second quality content data from the first recording medium, supplying the second quality content data to the decode processing portion, supplying output data of the decode processing portion to the recording portion, and recording the output data to the second recording medium in a copy mode of data read from the first record medium.

Claim 16 of the present invention is a recording medium reproducing method, comprising steps of: in a reproduction mode of a recording medium on which at least first quality content data and second quality content data whose quality is lower than the first quality content data have been encrypted and recorded, reading the first quality content data from the recording medium; and reproducing the first quality content data.

According to the present invention, since only first high quality content data can be reproduced, low quality content data can be prevented from being reproduced. As a result, the quality of a reproduced signal can be prevented from deteriorating. In addition, according to the present invention, only low quality content data can be output as a digital signal. As a result, high quality content data can be prevented from being illegally copied. Consequently, the copyright owner can provide contents without anxiety.

### BRIEF DESCRIPTION OF DRAWINGS

FIG. 1 is a block diagram showing an example of a conventional disc reproducing apparatus;

FIG. 2 is a partial sectional view for explaining an example of an optical disc according to the present invention;

FIG. 3 is a schematic diagram for explaining another example of an optical disc according to the present invention;

FIG. 4 is a block diagram showing an embodiment of the present invention;

FIG. 5 is a flow chart showing a process of an embodiment of the present invention;

FIG. 6 is a flow chart showing a process of an embodiment of the present invention;

FIG. 7 is a flow chart showing a process of an embodiment of the present invention;

FIG. 8 is a block diagram showing another embodiment of the present invention; and

FIG. 9 is a block diagram showing a further embodiment of the present invention.

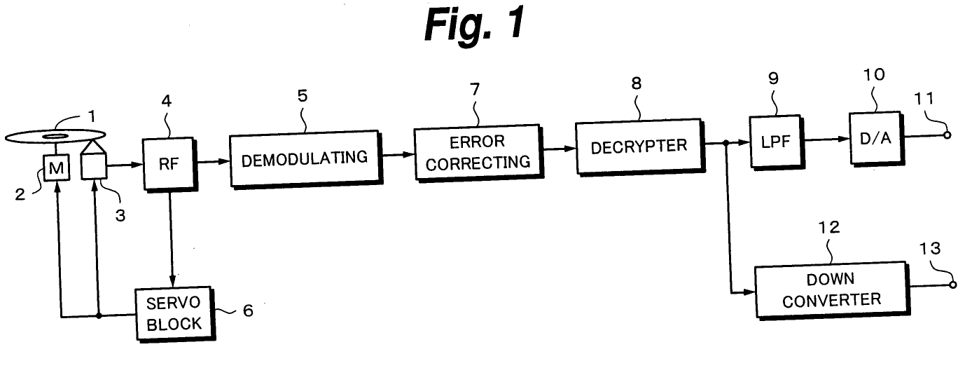

### BEST MODES FOR CARRYING OUT THE INVENTION

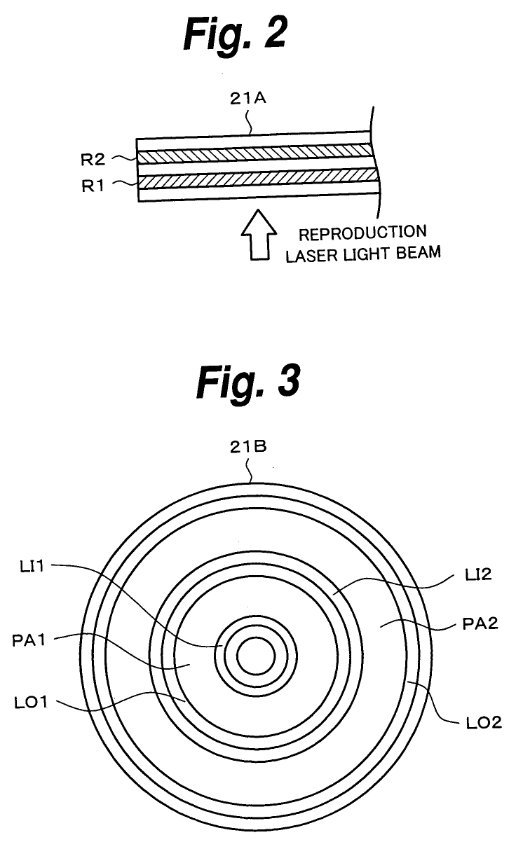

Next, an embodiment of the present invention will be described. According to the embodiment, the present invention is applied for an optical disc. In FIG. 2, reference numeral 21A represents an example of an optical disc as the recording medium according to the present invention. The optical disc 21A has two signal recording layers R1 and R2. A reproduction laser light beam is entered from one side of the optical disc 21A. When a laser light beam is focused on the signal recording layers R1 and R2, data can be read from the signal recording layers R1 and R2.

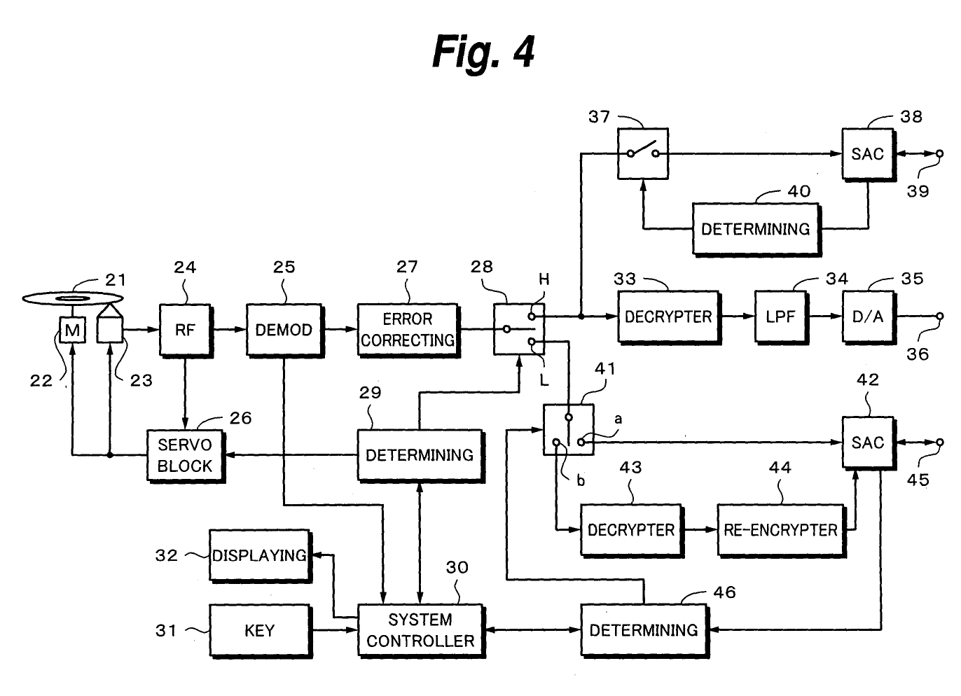

In FIG. 3, reference numeral 21B represents another example of an optical disc as the recording medium according to the present invention. In FIG. 3, the optical disc 21B has two recording areas. In other words, the recording area is divided into two portions in the radial direction. The divided portions are referred to as a first recording area PA1 and a second recording area PA2. A lead-in area LI1 is disposed on an outer periphery of a clamping area on the innermost periphery side of the optical disc 21B. The first recording area PA1 as a program area is disposed on an outer periphery side of the lead-in area LI1. A lead-out area LO1 is disposed on an outer periphery side of the first recording area PA1. A lead-in area LI2 is disposed on an outer periphery side of the lead-out area LO1. The second recording area PA2 as a program area is disposed on an outer periphery side of the lead-in area LI2. A lead-out area LO2 is disposed on an outer periphery side of the second recording area PA2.

The lead-in area LI1, the recording area PA1, and the lead-out area LO1 compose a first session. The lead-in area LI2, the recording area PA2, and the lead-out area LO2 compose a second session. Positions (addresses) of the first recording area PA1 and the second recording area PA2 on the disc have been recorded in the lead-in area LI1 which is first read when the optical disc 21B is loaded to a recording and/or reproducing apparatus. Identification data which identifies the optical disc 21B, which has the first session and the second session, namely the first recording area PA1 and the second recording area PA2, has been recorded in the lead-in area LI1.

First content data having a first quality and second content data having a second quality have been recorded on the forgoing optical disc. In this example, since the first quality is greater than the second quality, in the following description, the first quality is referred to as high quality and the second quality as low quality. For example, in the case of the two-layered optical disc 21A, high quality data has been recorded on the signal recording layer R1 which is close to an incident plane of a laser light beam, whereas low quality data has been recorded on the other signal recording layer R2. In the case of an optical disc having a plurality of sessions as shown in FIG. 3, namely the multi-session type optical disc 21B, high quality data and low quality data have been recorded in the first session and the second session, respectively. As was described above, it is not always necessary to fix the relation between signal recording layers and data qualities. However, when the relation is not fixed, it is necessary to record data which represents the relation between signal recording layers or sections and data qualities in the lead-in area LI1.

The high quality and low quality are relative evaluation characteristics. Generally, non-compressed audio data such as a linear PCM signal and WAV (audio file format which has been used as a standard format) is high quality data. Compressed audio data is low quality data. In addition, data corresponding to the DVD audio standard (in particular, 96 kHz sampling frequency and 24-bit quantization format) and data corresponding to the SACD (SuperAudio CD) standard are high quality data, whereas data corresponding to a CD-DA (Digital Audio) standard is low quality data. In the SACD standard, a DSD (Direct Stream Digital) system which directly handles AO modulated output data is used. One-bit stream data with a sampling frequency of 2.8224 MHz is recorded on a disc as a recording medium. Both high quality data and low quality data have been encrypted. However, it is not necessary to use the same encrypting system for high quality data and low quality data. Preferably, low quality data is compressed data. For low quality data, a compressing and encrypting process such as MP3, AC-3 (Audio Compression-3), or ATRAC (Adaptive Transform Acoustic Coding) can be used. When compressed data is copied from a particular recording medium to another recording medium, the copy time is short.

Next, with reference to FIG. 4, an optical disc reproducing apparatus according to an embodiment of the present invention will be described. Reference numeral 21 represents one of the two-layered optical disc 21A described with reference to FIG. 2 or the multi-session optical disc 21B described with reference to FIG. 3. The optical disc 21A or 21B is a ROM (Read Only Memory) type optical disc on which high quality data and low quality data have been recorded. For example, on the optical disc 21A or 21B, as high quality data, data corresponding to the DVD audio standard (in particular, 96 kHz sampling frequency, 24 bit quantization format) has been recorded, and as low quality data, data corresponding to the CD-DA standard or compressed data has been recorded.

The optical disc 21A or 21B is rotated at for example constant linear velocity by a spindle motor 22. A laser light beam is radiated from an optical pickup 23 to the optical disc 21A or 21B. Data recorded on the optical disc 21A or 21B is read by the optical pickup 23. An output signal of the optical pickup 23 is supplied to an RF processing block 24. The RF processing block 24 contains a pre-amplifier, an equalizer, and so forth. An RF signal as an output signal of the RF processing block 24 is supplied to a demodulating portion 25. A rotation servo of the spindle motor 22, a tracking servo and a focus servo of the optical pickup 23, and an operation of a motor (not shown) which travels the optical pickup 23 in the disc radial direction are controlled corresponding to a control signal supplied from a servo block 26.

The demodulating portion 25 demodulates the RF signal supplied from the RF processing block 24 corresponding to the 8-16 converting method. The demodulating portion 25 outputs eight-bit data corresponding to a 16-bit code. Output data of the demodulating portion 25 is supplied to an error correcting circuit 27. The error correcting circuit 27 corrects a detected error with an error correction code such as a product code using Reed-Solomon code added to the output data of the demodulating portion 25. Error-corrected output data of the error correcting circuit 27 is supplied to a selector 28.

A switching operation of the selector 28 is controlled corresponding to an output signal of a determining portion 29. The selector 28 selectively outputs reproduction data to an output terminal H or another output terminal L. Reference numeral 30 represents a system controller which controls overall operations of the optical disc reproducing apparatus. A key portion 31 which the user operates and a displaying portion 32 which displays a menu, an operation state, and so forth are connected to the system controller 30. TOC data which is read from the lead-in area of the optical disc 21A or 21B and address data of the optical disc are supplied from the demodulating portion 25 to the system controller 30.

The system controller 30 controls the determining portion 29 with an input signal corresponding to a key of the key portion 31 which the user has operated. The determining portion 29 controls the operations of the servo block 26 and the selector 28. The determining portion 29 controls the servo block 26 in different manners depending on whether the optical disc 21 is a two-layered disc or a multi-session disc. When the optical disc 21 is a two-layered disc, the determining portion 29 controls the servo block 26 so that a laser light beam is focused on the first recording layer or the second recording layer. When the optical disc 21 is a multi-session disc, the determining portion 29 controls the reproducing position of the optical pickup 23. The case that the reproducing position of the optical pickup 23 is controlled and the controlling method will be described later in detail.

The output terminal H of the selector 28 is selected when high quality data is output. The high quality data is supplied from the error correcting circuit 27 to a decrypter 33 and a gate 37. The decryptor 33 decrypts data which has been encrypted. When the optical disc 21 uses the same encrypting system as the DVDs, the decrypter 33 decrypts encrypted data with the media ID data of the optical disc 21. Digital audio data which is output from the decrypter 33 is supplied to a D/A converter 35 through a low pass filter 34. The D/A converter 35 outputs an analog signal as a reproduction audio signal to an output terminal 36. For example, the D/A converter 35 converts data sampled at a frequency of 96 kHz and quantized with 24 bits corresponding to the DVD audio standard into an analog audio signal and outputs the analog audio signal to the output terminal 36.

A secure block 38 (which is represented as SAC (Secure Authentication Channel) in FIG. 4) is connected to the gate 37. A reproducing apparatus as an external device (for example, a digital amplifier) is connected to the secure block 38 through an output terminal 39. The secure block 38 authenticates the connected digital amplifier. Only when the secure block 38 has correctly authenticated the digital amplifier, the secure block 38 determines the digital amplifier as an authorized digital amplifier. In other words, when the digital amplifier is a permitted reproducing apparatus, the secure block 38 outputs the digital signal to the digital amplifier. Thus, the digital amplifier can reproduce the digital signal. When the external device is not an authorized apparatus such as a digital recorder, the secure block 38 prohibits the digital signal from being output from the output terminal 39.

The authenticated result of the secure block 38 is supplied to a determining portion 40. An output signal of the determining portion 40 causes on/off state of the gate 37 to be switched. In other words, when the secure block 38 has correctly authenticated the digital amplifier connected to the output terminal 39 as an authorized apparatus, the gate 37 is switched to the on state. As a result, the digital amplifier can reproduce the high quality digital signal or digital data.

The reproducing apparatus shown in FIG. 4 and other reproducing apparatuses according to other embodiments which will be described later can be accomplished by a personal computer and software besides dedicated hardware.

Low quality data has been encrypted and preferably compressed. The low quality data is supplied to a selector 41 through the other output terminal L of the selector 28. The selector 41 has output terminals a and b. Data obtained from the output terminal a is supplied to a secure block 42. Data obtained from the output terminal b of the selector 41 is supplied to a decrypter 43 which decrypts encrypted data. Output data of the decrypter 43 is re-encrypted by a re-encrypter 44. Output data of the re-encrypter 44 is supplied to the secure block 42. Digital data of the secure block 42 is obtained from a digital output terminal 45.

The authenticated result of the secure block 42 is supplied to a determining portion 46. The determining portion 46 generates a select signal which is used to control the selector 41. The determining portion 46 is controlled by the system controller 30. The determining portion 46 permits or prohibits the digital data to be output or from being output corresponding to the authenticated result of the secure block 42. In other words, when the secure block 42 has correctly authenticated the recording apparatus connected to the output terminal 45 as an authorized recording apparatus, the secure block 42 permits the digital data to be output. When the secure block 42 has not correctly authenticated the recording apparatus as an authorized apparatus, since there is a risk of which the recording apparatus may illegally copy the digital data, the selector 41 is controlled with the select signal supplied from the determining portion 46 so that the digital data is not output from the selector 41. For example, the selector 41 is connected to the output terminal b. The output data of the error correcting circuit 27 is re-encrypted by the re-encrypter 44. The re-encrypted data is output from the output terminal 45. Of course, the selector 41 may be switched to the off state so that the digital data is prohibited from being output from the selector 41.

When the reproducing apparatus shown in FIG. 4 has correctly authenticated the recording apparatus connected to the output terminal 45 as an authorized apparatus, depending on whether or not data is re-encrypted, the selector 41 is controlled. When output data of the error correcting circuit 27 is not re-encrypted, the output terminal a of the selector 41 is selected. When the output data of the error correcting circuit 27 is re-encrypted, the output terminal b of the selector 41 is selected. Whether or not the output data is re-encrypted is selected by the user. Alternatively, whether or not the output data is re-encrypted may be controlled depending on the type of the apparatus connected to the output terminal 45. For example, when a personal computer is connected to the output terminal 45, data which is output from the output terminal 45 is re-encrypted. In contrast, when the apparatus connected to the output terminal 45 is a consumer apparatus, data which is output from the output terminal 45 is not re-encrypted. When data which had been output from the output terminal 45 had been re-encrypted, even if the data had been decrypted, the resultant data has been still encrypted. As a result, the data can be securely protected.

Next, controlling methods of the selector 28 will be described. The selector 28 can be controlled in the following two methods. In the first method, depending on what position the optical pickup 23 is reading, the selector 28 is controlled. The system controller 30 can recognize which areas or layers high quality data and low quality data have been recorded with information of TOC data. Thus, when the current reproducing position which is the read position of the optical pickup 23 is in a high quality recording area or a high quality recording layer, the determining portion 29 is controlled corresponding to a control signal received from the system controller 30 so that the selector 28 selects the output terminal H. When the current reproducing position is in the low quality recording area or recording layer, the determining portion 29 is controlled corresponding to a control signal received from the controller 30 so that the selector 28 selects the output terminal L.

In the second method, the selector 28 and the access of the optical disc are controlled corresponding to an operation mode designated by the user. When the user designates a reproduction operation with a predetermined key of the key portion 31, the controller 30 generates a control signal for the servo block 26 so that the selector 28 selects the output terminal H and the reproducing position is in the high quality data recording area or recording layer. On the other hand, when the user operates a key for a copy operation with the key portion 31, the system controller 30 supplies a control signal to the servo block 26 so that the selector 28 selects the output terminal L and the reproducing position is in the low quality data recording area or recording layer. In addition, the user may be able to select the first method or the second method.

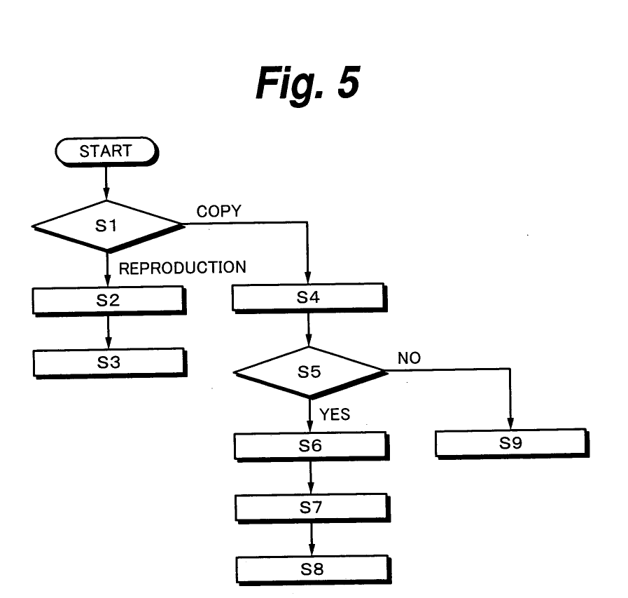

FIG. 5 is a flow chart showing a process for controlling the selector 28 and the access of the optical disc corresponding to an operation mode. This process is performed by the determining portion 29, the system controller 30, and the determining portion 46. At the first step S1, it is determined whether the operation mode of the reproducing apparatus shown in FIG. 4 is a reproduction operation or a copy operation (or digital output operation). When the determined result at step S1 represents that the operation mode is the reproduction operation, the access of the optical pickup 23 is controlled so that high quality content data is read from the optical disc 21 (at step S2). The high quality content data which is read from the optical disc 21 is reproduced (at step S3). An analog reproduction output signal is obtained from the output terminal 36. When the external device has been correctly authenticated as a reproducing apparatus, a digital reproduction output signal is obtained from the output terminal 39.

When the determined result at step S1 represents that the operation mode is the copy operation, the flow advances to step S4. At step S4, the low quality content data is accessed from the optical disc 21. At step S5, it is determined whether or not data which has been read from the optical disc 21 has to be re-encrypted. As was described above, when a personal computer is connected to the output terminal 45, it is determined that data which is output from the output terminal 45 has to be re-encrypted. At step S6, the decrypter 43 decrypts the encrypted output data of the error correcting circuit 27. At step S7, the re-encrypter 44 re-encrypts output data of the error correcting circuit 27 with new key data. The re-encrypted data is output from the output terminal 45 through the secure block 42 (at step S8). When the determined result at step S5 represents that output data of the error correcting circuit 27 does not have to be re-encrypted, the flow advances to step S9. At step S9, the output data of the error correcting circuit 27 is output from the output terminal 45.

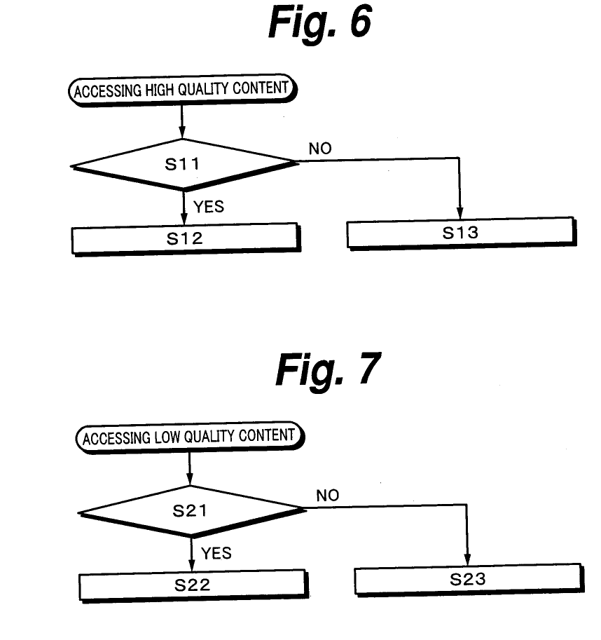

A flow chart shown in FIG. 6 represents a process for accessing high quality content data of the optical disc 21. At step S11, it is determined whether or not the operation mode is the reproduction mode. When the operation mode is the reproduction mode, the flow advances to step S12. At step S12, high quality data is read from the optical disc 21 and reproduced. When the determined result represents that the operation mode is not the reproduction mode, the reproduction operation is stopped (at step S13).

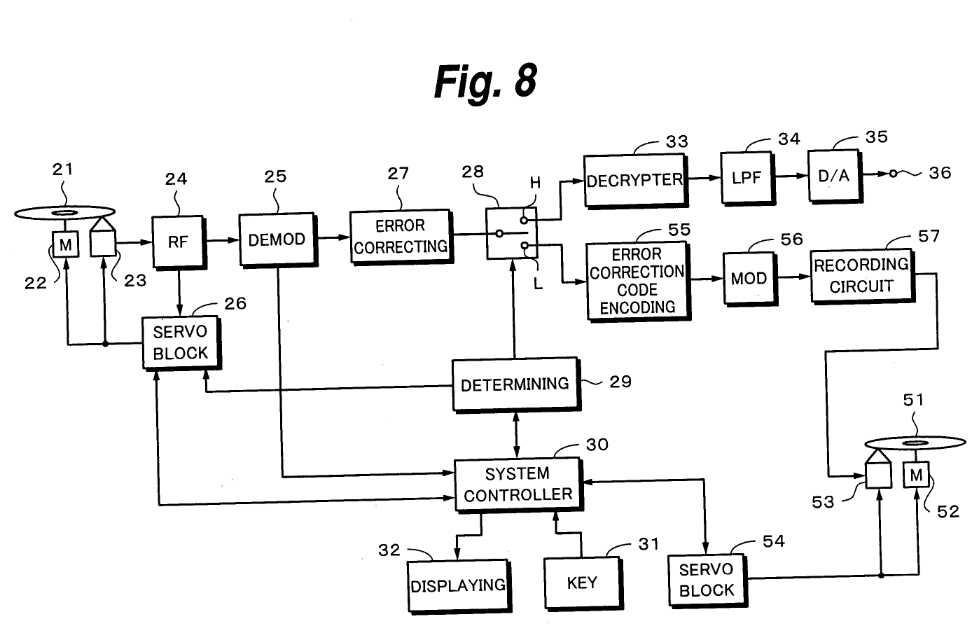

A flow chart shown in FIG. 7 represents a process for accessing low quality content data of the optical disc 21. At step S21, it is determined whether or not the operation mode is the reproduction mode. When the operation mode is the reproduction mode, the flow advances to step S22. At step S22, the reproduction operation is stopped. When the operation mode is not the reproduction mode, digital data is output from the output terminal 45 (at step S23).

Next, with reference to FIG. 8, another embodiment of the present invention will be described. The embodiment is applied for a so-called double deck structure having two optical disc drives. In the example shown in FIG. 8, a first optical disc drive is a reproducing apparatus portion, whereas a second optical disc drive is a recording apparatus portion. Reference numeral 51 represents a recordable optical disc for example a DVD-R (DVD-Recordable) disc. As the optical disc 51, a rewritable optical disc or a write-once type optical disc for example a CD-R (Recordable) disc, a CD-RW (ReWritable) disc, or a DVR (Digital Video Recording System) disc can be used. The optical disc 51 is rotated at for example constant linear velocity or constant angular velocity by a spindle motor 52. The spindle motor 52 and an optical pickup 53 are controlled by a servo block 54.

The servo block 54 is controlled by a system controller 30. Address information which is read from the optical disc 51 by the optical pickup 53 is supplied to the system controller 30. Data is recorded at a predetermined address of the optical disc 51. The address information has been recorded on for example wobbling grooves formed on the optical disc 51. In other words, grooves which wobble with a small amplitude in the disc radial direction have been formed on the optical disc 51. As wobbling information, FM modulated address information can be recorded along with clock information.

A determining portion 29 which controls a selector 28 has the same function as that according to the embodiment shown in FIG. 4. The determining portion 29 controls the selector 28 so that in the reproduction mode the selector 28 selects an output terminal H and in the copy mode, the selector 28 selects an output terminal L. High quality data obtained from the output terminal H of the selector 28 is supplied to a decrypter 33. The decrypter 33 decrypts high quality data which has been encrypted. The decrypted data is supplied to a D/A converter 35 through a low pass filter 34 which limits a predetermined frequency band. The resultant data is obtained as an analog reproduction output signal from an output terminal 36.

When the operation mode is the copy mode, low quality data which is obtained from the output terminal L of the selector 28 is supplied to an error correction code encoding circuit 55. The error correction code encoding circuit 55 encodes the low quality data with a product code using Reed-Solomon code. Output data of the error correction code encoding circuit 55 is supplied to a modulating portion 56. The modulating portion 56 modulates the output data of the error correction code encoding circuit 55 corresponding to the 8-16 modulating method. Output data of the modulating portion 56 is supplied to a recording circuit 57.

The recording circuit 57 performs a process for adding a frame synchronous signal and address data, and so forth. A laser driving portion of the recording circuit 57 generates a predetermined drive signal which causes record data to be recorded on the optical disc 51. The drive signal of the laser driving portion is supplied to a semiconductor laser of the optical pickup 53. The semiconductor laser radiates a laser light beam which has been modulated corresponding to the drive signal to the optical disc 51. As a result, data corresponding to the laser light beam is recorded on the optical disc 51.

According to the forgoing embodiment, low quality data which has been encrypted and recorded on the optical disc 21 is directly copied to the optical disc 51. Preferably, the low quality data is copied at n times higher speed than the reproduction speed (where n is 4, 8, 16, 24, etc). When the low quality data has been compressed, it can be copied at a higher speed than non-compressed data.

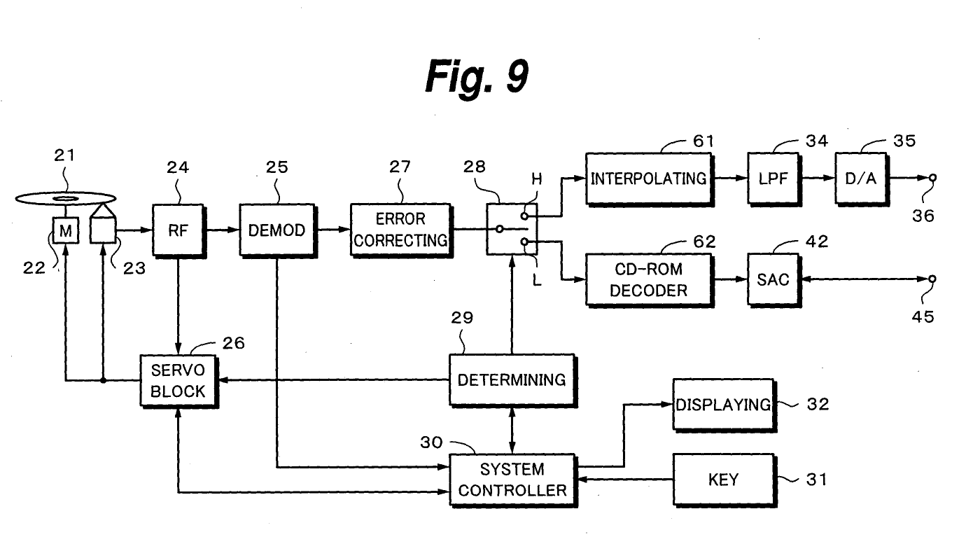

Next, with reference to FIG. 9, a reproducing apparatus according to a further embodiment of the present invention will be described. In FIG. 9, an optical disc 21 is a multi-session optical disc shown in FIG. 3. Linear PCM data according to the same standard as the CD-DA (high quality data) has been recorded in a first session on an inner periphery side of the optical disc 21. Compressed audio data corresponding to the CD-ROM standard (low quality data) has been recorded in a second session on an outer periphery side of the optical disc 21. The low quality data has been encrypted. The shape and physical characteristic of the optical disc 21 are the same as those of a CD-DA. The record density of the first session is equal to that of the CD-DA. The record density of the second section is equal to or greater than that of the CD-DA. When the track pitch and linear velocity of the optical disc 21 are decreased, data can be recoded with a high density. When data is recorded with a high density, the reproducing apparatus has to change the linear velocity between the first session and the second session.

A reproduction output signal of the optical pickup 23 is supplied to an RF processing block 24. An RF signal is supplied to an EFM (Eight to Fourteen Modulation) decoding portion 25. A tracking error signal and a focus error signal are supplied to a servo block 26. Demodulated output data of the demodulating portion 25 is supplied to an error correcting circuit 27. Address information (time information) obtained from the demodulating portion 25 is supplied to a system controller 30. An error correcting circuit 27 detects an error and performs an error correcting process corresponding to a CIRC (Cross Interleaved Reed Solomon Code).

Output data of the error correcting circuit 27 is supplied to a selector 28 which is controlled with an output signal of a determining portion 29. The determining portion 29 controls the selector 28 corresponding to a reproducing position, namely a read position of the optical disc 21 by the optical pickup 23. In addition, the determining portion 29 controls the selector 28 corresponding to an operation mode. High quality data which is obtained from an output terminal H is supplied to an interpolating circuit 61. The interpolating circuit 61 interpolates an error which has not been corrected by the error correcting circuit 27. Output data of the interpolating circuit 61 is supplied to a D/A converter 35 through a low pass filter 34. An analog reproduction output signal which is output from the D/A converter 35 is obtained from an output terminal 36.

Low quality data which is obtained from an output terminal L of the selector 28 is supplied to a CD-R decoder 62. The CD-R decoder 62 performs a decoding process for the low quality data. Audio data which has been encrypted and compressed is output from the CD-R decoder 62. Output data of the CD-R decoder 62 is supplied to a secure block 42. The secure block 42 authenticates a recording apparatus connected to an output terminal 45. When the secure block 42 has correctly authenticated the recording apparatus as an authorized apparatus, the secure block 42 outputs data to the recording apparatus. As with the apparatus shown in FIG. 4, when the apparatus connected to the output terminal 45 is a personal computer, the data may be re-encrypted and output from the output terminal 45.

Although the present invention has been shown and described with respect to a best mode embodiment thereof, it should be understood by those skilled in the art that the foregoing and various other changes, omissions, and additions in the form and detail thereof may be made therein without departing from the spirit and scope of the present invention. For example, the present invention can be applied for other data recording mediums besides optical discs. The present invention can be applied for picture data besides audio data. For example, when high resolution video content data and low resolution video content data have been recorded, only the high resolution video content data may be reproduced and the low resolution video content data may be directly output. When video software titles (namely, video content data) having different compression rates have been recoded on one optical disc, only high quality data which has been compressed at low compression rate may be reproduced and low quality data which has been compressed at high compression rate may be directly output.

According to the present invention, since only high quality data is reproduced, the quality of the reproduction content can be assured. In addition, according to the present invention, since only low quality data is digitally copied, the copyright owner can provide contents without anxiety. In addition, according to the present invention, since digital output data is generated, it is not necessary to dispose hardware such as a down converter which converts a data quality.

1. A recording medium reproducing apparatus, comprising:
a head portion for reading data from a recording medium on which at least first quality content data and second quality content data have been recorded;
a decode processing portion for receiving an output signal of the head portion and decoding the received output signal; and
a controlling portion for causing the head portion to read the first quality content data from the recording medium, supplying the first quality content data to the decode processing portion, and outputting output data of the decode processing portion in a reproduction mode of the recording medium.

2. The recording medium reproducing apparatus as set forth in claim 1, further comprising:
a conversion processing portion for converting the output data of the decode processing portion into an analog signal in the reproduction mode of the recording medium.

3. The recording medium reproducing apparatus as set forth in claim 1, further comprising:
a processing portion for authenticating a device connected to the apparatus,
wherein when the processing portion has correctly authenticated the device, the output data of the decode processing portion is output to the device connected to the apparatus.

4. The recording medium reproducing apparatus as set forth in claim 1,
wherein in a copy mode for data recorded on the recording medium, the second quality content data is read from the recording medium by the head portion, the second quality content data being supplied to the decode processing portion, output data of the decode processing portion being output.

5. The recording medium reproducing apparatus as set forth in claim 4, further comprising:
encryption processing portion for encrypting the output data of the decode processing portion,
wherein the output data of the decode processing portion is supplied to the encryption processing portion corresponding to an authenticated result of a device connected to the apparatus.

6. The recording medium reproducing apparatus as set forth in claim 5, further comprising:
a processing portion for authenticating the device connected to the apparatus,
wherein the controlling portion is configured to control whether to supply the output data of the decode processing portion to the encryption processing portion corresponding to an authenticated result of the processing portion.

7. A recording medium reproducing method, comprising the steps of:
in a reproduction mode of a recording medium on which at least first quality content data and second quality content data whose quality is lower than the first quality content data have been recorded, reading the first quality content data from the recording medium;
decoding the first quality content data which has been read; and
outputting the decoded data as output data.

8. The recording medium reproducing method as set forth in claim 7, further comprising the steps of:
converting the decoded data into an analog signal; and
outputting the analog signal.

9. The recording medium reproducing method as set forth in claim 7, further comprising the steps of:
authenticating an external device to which the decoded data is output;
when the external device has been correctly authenticated, outputting the decoded data to the external device; and
when the external device has not been correctly authenticated, prohibiting the decoded data from being output.

10. The recording medium reproducing method as set forth in claim 7, further comprising the steps of:
in a copy mode of data recorded on the recording medium, reading the second quality content data from the recording medium;
decoding the second quality content data; and
outputting the decoded data.

11. The recording medium reproducing method as set forth in claim 10, further comprising the steps of:
authenticating an external device to which the decoded data is output;
when the external device has been correctly authenticated, outputting the decoded data to the external device; and
when the external device has not been correctly authenticated, prohibiting the decoded data from being output.

12. The recording medium reproducing method as set forth in claim 10, further comprising the steps of:
authenticating an external device to which the decoded data is output;
encrypting the decoded data corresponding to a type of the external device which is based on the authenticated result; and
outputting the encoded data.

13. A recording medium recording and reproducing apparatus, comprising:
a read head portion for reading data from a first recording medium on which at least first quality content data and second quality content data whose quality is lower than the first quality content data have been recorded;
a decode processing portion for receiving an output signal of the header portion and decoding the received output signal;
a recording portion for encoding output data of the decode processing portion so as to record the encoded data to a second recording medium;
a controlling portion for causing the read head portion to read the second quality content data from the first recording medium, supplying the second quality content data to the decode processing portion, supplying output data of the decode processing portion to the recording portion, and recording the output data to the second recording medium in a copy mode of data read from the first record medium.

14. The recording medium recording and reproducing apparatus as set forth in claim 13,
wherein the controlling portion is configured to cause the read head portion to read the first quality content data from the first recoding medium, supply the first quality content data to the decode processing portion, and output output data of the decode processing portion.

15. The recording medium recording and reproducing apparatus as set forth in claim 14, further comprising:
a conversion processing portion for converting the output data of the decode processing portion into an analog signal in a reproduction mode of the recoding medium.

16. A recording medium reproducing method, comprising steps of:
in a reproduction mode of a recording medium on which at least first quality content data and second quality content data whose quality is lower than the first quality content data have been encrypted and recorded, reading the first quality content data from the recording medium; and
reproducing the first quality content data.

17. The recording medium reproducing method as set forth in claim 16, further comprising the steps of:
decoding the first quality content data which has been encrypted and read from the record medium;
decrypting the decoded data; and
outputting the decrypted data as output data.

18. The recording medium reproducing method as set forth in claim 17, further comprising the steps of:
converting the decrypted data into an analog signal; and
outputting the analog signal.

19. The recording medium reproducing method as set forth in claim 18, further comprising the steps of:
authenticating an external device to which the decoded data is output;
when the external device has been correctly authenticated, outputting the decoded data to the external device; and
when the external device has not been correctly authenticated, prohibiting the decoded data from being output.

20. The recording medium reproducing method as set forth in claim 16, further comprising the steps of:
in a copy mode for data recorded on the recoding medium, reading the second quality content data which has been encrypted from the recording medium;
decoding the second quality content data which has been encrypted; and
outputting the decoded data.

21. The recording medium reproducing method as set forth in claim 20, further comprising the steps of:
authenticating an external device to which the decoded data is output;
when the external device has been correctly authenticated, outputting the decoded data to the external device; and
when the external device has not been correctly authenticated, prohibiting the decoded data from being output.

22. The recording medium reproducing method as set forth in claim 20, further comprising the steps of:
authenticating an external device to which the decoded data is output;
temporarily decrypting the decoded data corresponding to a type of the external device based on the authenticated result;
re-encrypting the decrypted data; and
outputting the re-encrypted data.
